(19) United States
(12) Patent Application Publication
(10) Pub. No.: US 2025/0350981 A1
(43) Pub. Date: Nov. 13, 2025

(54) METHOD, DEVICE AND COMPUTER STORAGE MEDIUM OF COMMUNICATION

(71) Applicant: NEC Corporation, Minato-ku, Tokyo (JP)

(72) Inventors: Da WANG, Beijing (CN); Gang WANG, Beijing (CN)

(73) Assignee: NEC Corporation, Minato-ku, Tokyo (JP)

(21) Appl. No.: 18/860,078

(22) PCT Filed: Apr. 27, 2022
(86) PCT No.: PCT/CN2022/089665

§ 371 Date: Oct. 25, 2024

(51) Int. Cl. H04W 24/10; H04L 27/26

(52) U.S. Cl. CPC H04W 24/10; H04L 27/261

(57) ABSTRACT

Embodiments of the present disclosure relate to methods, devices and computer readable media for communication. A source DU transmits, to a CU, first information regarding at least one candidate cell for a lower-layer signaling based cell change or addition; and receives, from the CU, second information regarding a target cell for the lower-layer signaling based cell change or addition. In this way, CU-DU interworking for L1/L2 based mobility may be defined.

### TECHNICAL FIELD

Embodiments of the present disclosure generally relate to the field of telecommunication, and in particular, to methods, devices and computer storage media of communication based on a lower-layer signaling.

### BACKGROUND

When user equipment (UE) moves from a coverage area of one cell to that of another cell, a change or addition or release of a serving cell may need to be performed. Currently, the change or addition or release of the serving cell is triggered by layer 3 (L3) measurements and is done by radio resource control (RRC) signaling triggered Reconfiguration with Synchronization for change of primary cell (PCell) and primary secondary cell (PSCell). All cases involve complete layer 2 (L2) and layer 1 (L1) resets, leading to longer latency, larger overhead and longer interruption time than beam switch mobility.

Some solutions to the above issue are proposed based on a lower-layer signaling such as layer 1 (L1) or layer 2 (L2) signaling. In one solution, a data transmission is performed with a change of a serving cell upon reception of the lower-layer signaling, which is also referred to as a L1/L2 based mobility. In this way, the latency, overhead and interruption time may be reduced. However, central unit (CU)-distributed unit (DU) interface signaling to support a L1/L2 based mobility procedure need to be further developed.

### SUMMARY

In general, embodiments of the present disclosure provide methods, devices and computer storage media of communication based on a lower-layer signaling.

In a first aspect, there is provided a method of communication. The method comprises: transmitting, at first DU and to a CU, first information regarding at least one candidate cell for a lower-layer signaling based cell change or addition; and receiving, from the CU, second information regarding a target cell for the lower-layer signaling based cell change or addition.

In a second aspect, there is provided a method of communication. The method comprises: determining, at a first DU a target cell for a lower-layer signaling based cell change or addition; and transmitting, to a CU, third information indicating that the lower-layer signaling based cell change or addition is triggered for the target cell.

In a third aspect, there is provided a method of communication. The method comprises: receiving, at a CU and from a first DU, first information regarding at least one candidate cell for a lower-layer signaling based cell change or addition; determining, based on the first information, a target cell for the lower-layer signaling based cell change or addition; and transmitting, to the first DU, second information regarding the target cell for the lower-layer signaling based cell change or addition.

In a fourth aspect, there is provided a method of communication. The method comprises: receiving, at a CU and from a first DU, third information indicating that a lower-layer signaling based cell change or addition is triggered for a target cell.

In a fifth aspect, there is provided a method of communication. The method comprises: receiving, at a second DU and from a CU, an indication indicating that a lower-layer signaling based cell change or addition is to be triggered for a target cell, the target cell being associated with the second DU; and transmitting, to the CU, an acknowledgement for the triggering.

In a sixth aspect, there is provided a DU. The DU comprises a processor configured to cause the DU to perform the method according to the first or second or fifth aspect of the present disclosure.

In a seventh aspect, there is provided a CU. The CU comprises a processor configured to cause the CU to perform the method according to the third or fourth aspect of the present disclosure.

In an eighth aspect, there is provided a computer readable medium having instructions stored thereon. The instructions, when executed on at least one processor, cause the at least one processor to perform the method according to the first or second or fifth aspect of the present disclosure.

In a ninth aspect, there is provided a computer readable medium having instructions stored thereon. The instructions, when executed on at least one processor, cause the at least one processor to perform the method according to the third or fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating network protocol layer entities that may be established for a user plane (UP) protocol stack at devices according to some embodiments of the present disclosure;

FIG. 1C illustrates a schematic diagram illustrating network protocol layer entities that may be established for a control plane (CP) protocol stack at devices according to some embodiments of the present disclosure;

FIG. 1D illustrates a schematic diagram of a central unit (CU)/distributed unit (DU) architecture in which some embodiments of the present disclosure can be implemented;

FIG. 1E illustrates a schematic diagram illustrating a process of L1/L2 based mobility in which some embodiments of the present disclosure can be implemented;

FIG. 2 illustrates a schematic diagram illustrating a process of a candidate cell configuration for L1/L2 based mobility according to embodiments of the present disclosure;

FIG. 3 illustrates a schematic diagram illustrating a process of a lower-layer measurement configuration for L1/L2 based mobility according to embodiments of the present disclosure;

FIG. 4A illustrates a schematic diagram illustrating a process of triggering a L1/L2 based mobility according to embodiments of the present disclosure;

FIG. 4B illustrates a schematic diagram illustrating another process of triggering a L1/L2 based mobility according to embodiments of the present disclosure;

FIG. 4C illustrates a schematic diagram illustrating still another process of triggering a L1/L2 based mobility according to embodiments of the present disclosure;

FIG. 5 illustrates an example method of communication implemented at a source DU in accordance with some embodiments of the present disclosure;

FIG. 6 illustrates another example method of communication implemented at a source DU in accordance with some embodiments of the present disclosure;

FIG. 7 illustrates an example method of communication implemented at a CU in accordance with some embodiments of the present disclosure;

FIG. 8 illustrates another example method of communication implemented at a CU in accordance with some embodiments of the present disclosure;

FIG. 9 illustrates an example method of communication implemented at a target DU in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “a cell change or addition” may be interchangeably used with “reconfiguration with sync for secondary cell group (SCG) or master cell group (MCG)”. The term “PSCell” refers to a SpCell of a SCG, the term “PCell” refers to a SpCell of a MCG, and the term “SpCell” refers to a primary cell of a SCG or MCG. The term “SCell” refers to a secondary cell. The term “L1/L2 based mobility” may be interchangeably used with “L1/L2 based mobility procedure” or “a lower-layer signaling based cell change or addition” or “L1/L2 based handover”. The term “lower-layer signaling” may be interchangeably used with “L1/L2 signaling”. The term “RRC reconfiguration” may be interchangeably used with “RRC reconfiguration message”. The term “data transmission” refers to the transmitting and receiving of data.

Currently, it is proposed to specify mechanisms and procedures of L1/L2 based mobility for mobility latency reduction for the following aspects:
configuration and maintenance for multiple candidate cells to allow fast application of configurations for candidate cells;
dynamic switch mechanism among candidate serving cells (including SpCell and SCell) for the potential applicable scenarios based on L1/L2 signaling;
L1 enhancements for inter-cell beam management, including L1 measurement and reporting, and beam indication;
timing advance (TA) management;
CU-DU interface signaling to support L1/L2 mobility, if needed.

The procedure of L1/L2 based mobility may be applicable to the following scenarios:
standalone, carrier aggregation (CA) and new radio (NR)-dual connectivity (DC) case with serving cell change within one cell group (CG);
intra-DU case and intra-CU inter-DU case (applicable for Standalone and CA: no new RAN interfaces are expected);
both intra-frequency and inter-frequency;
both frequency range 1 (FR1) and frequency range 2 (FR2);
source and target cells may be synchronized or non-synchronized.

Embodiments of the present disclosure provide solutions of CU-DU interface signaling so as to support L1/L2 based mobility.

In one aspect, embodiments of the present disclosure provide solutions for preparing candidate cells for L1/L2 based mobility under a CU-DU scenario. In another aspect, embodiments of the present disclosure provide solutions for enabling a DU to be aware of a lower-layer measurement configuration of other DUs. In still another aspect, embodiments of the present disclosure provide solutions for triggering L1/L2 based mobility under a CU-DU scenario. In this way, a CU-DU interworking mechanism is defined for L1/L2 based mobility.

Principles and implementations of the present disclosure will be described in detail below with reference to the figures.

### Example of Communication Network

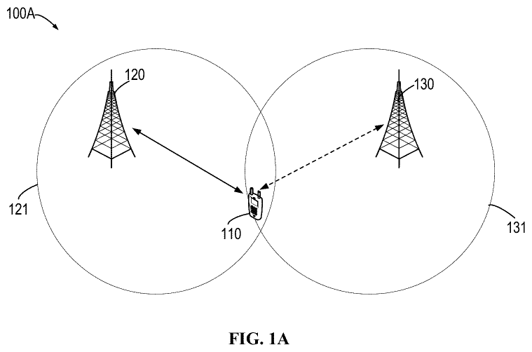

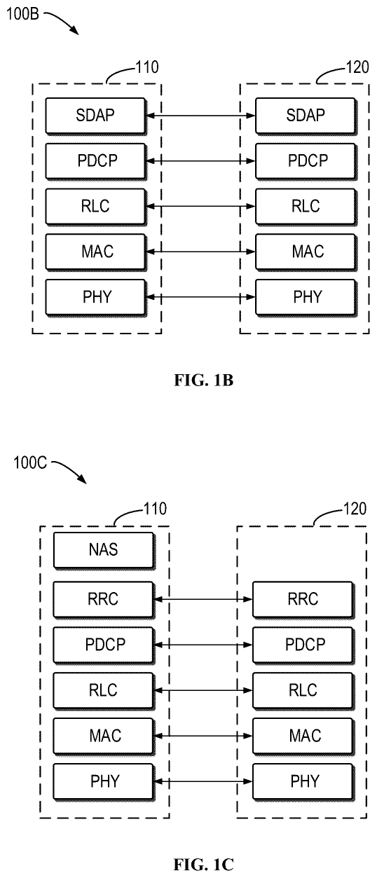

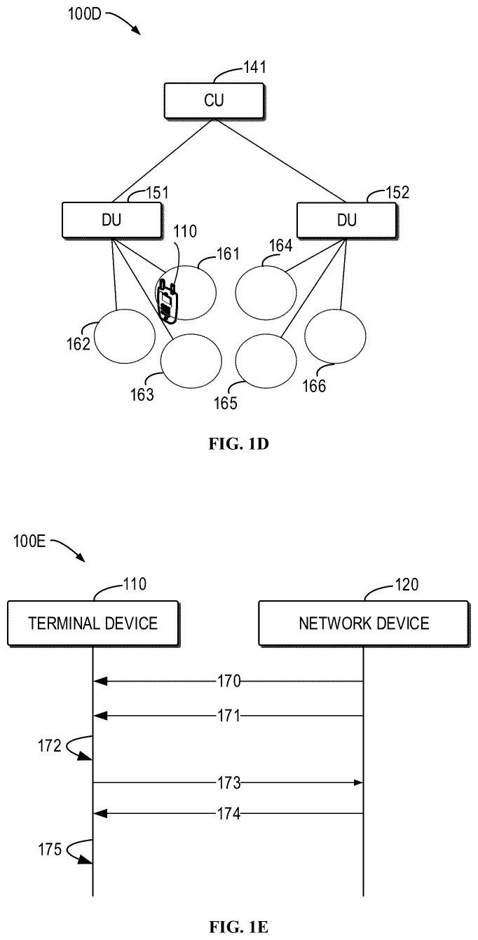

FIG. 1A illustrates a schematic diagram of an example communication network 100A in which some embodiments of the present disclosure can be implemented. As shown in FIG. 1A, the communication network 100A may include a terminal device 110 and a plurality of network devices 120 and 130 (for convenience, also referred to as a network device 120 and a network device 130 herein). The network devices 120 and 130 provide respective cells 121 and 131 to serve a terminal device.

It is to be understood that the number of devices in FIG. 1A is given for the purpose of illustration without suggesting any limitations to the present disclosure. The communication network 100A may include any suitable number of network devices and/or terminal devices adapted for implementing implementations of the present disclosure. Further, each of the network devices 120 and 130 may provide more cells for the terminal device 110.

As shown in FIG. 1A, the terminal device 110 may communicate with the network device 120 or 130 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 110 towards the network device 120 or 130 is referred to as uplink (UL) communication, while communication in a reverse direction from the network device 120 or 130 towards the terminal device 110 is referred to as downlink (DL) communication. The terminal device 110 can move amongst the cells of the network devices 120, 130 and possibly other network devices. In UL communication, the terminal device 110 may transmit UL data and control information to the network device 120 or 130 via a UL channel. In DL communication, the network device 120 or 130 may transmit DL data and control information to the terminal device 110 via a DL channel.

The communications in the communication network 100A can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure. For convenience, the following description is given by taking a communication between the terminal device 110 and the network device 120 as an example. It is to be understood that the following description is also suitable for the communication between the terminal device 110 and the network device 130.

In some embodiments, the network devices 120 and 130 may be different network devices. In some embodiments, the network devices 120 and 130 may be the same network device.

As shown in FIG. 1B, in the UP, each of the terminal device 110 and the network device 120 may comprise an entity for the L1 layer, i.e., an entity for a physical (PHY) layer (also referred to as a PHY entity), and one or more entities for upper layers (L2 and layer 3 (L3) layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

In the context of the present disclosure, L1 refers to the PHY layer, L2 refers to the MAC or RLC or PDCP or SDAP layer, and L3 refers to the RRC layer. In the context of the present disclosure, L1 or L2 may also be collectively referred to as a lower-layer, and L3 may also be referred to as a higher-layer. Accordingly, L1 or L2 signaling may be also referred to as a lower-layer signaling, and L3 signaling may be also referred to as a higher-layer signaling.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a PDCCH, a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. Four types of SRBs may be defined in a RRC layer, i.e., SRB0, SRB1, SRB2 and SRB3. SRB0 uses a CCCH for RRC connection establishment or re-establishment. SRB1 uses a DCCH and is established when RRC connection is established. SRB2 uses a DCCH and is established during RRC reconfiguration and after initial security activation. SRB3 uses a DCCH and is established between the terminal device 110 and SN when a dual connection is established.

FIG. 1D illustrates a schematic diagram 100D of a CU/DU architecture in which some embodiments of the present disclosure can be implemented. The CU/DU architecture may be established at a network device.

In the context of the present disclosure, a CU (also referred to as a gNB-CU herein) is a logic node hosting RRC, SDAP and PDCP protocols of a gNB or RRC and PDCP protocols of an en-gNB that controls operation of one or more DUs (also referred to as gNB-DUs herein). The gNB-CU terminates a F1 interface connected with the gNB-DU. A DU is a logical node hosting RLC, MAC and PHY layers of the gNB or en-gNB, and its operation is partly controlled by gNB-CU. One gNB-DU supports one or multiple cells. One cell is supported by only one gNB-DU. The gNB-DU terminates a F1 interface connected with the gNB-CU.

As shown in FIG. 1D, CU 141 is shown. It is to be understood that more CUs may be comprised. The CU 141 may communicate with multiple DUs. Here, two DUs 151 and 152 are shown for illustration. It is to be understood that more DUs may also be provided for implementation of embodiments of the present disclosure. Although not shown, CU 141 may be responsible for accomplishing the functionalities of the SDAP entity and the PDCP entity, and DU 151 or 152 may be responsible for accomplishing the functionalities of the RLC entity, the MAC entity and the PHY entity.

DU 151 may provide cells 161, 162 and 163. DU 152 may provide cells 164, 165 and 166. It is to be understood that this is merely an example, and more or less cells are also feasible. The terminal device 110 may communicate with any of these cells.

In some embodiments, the terminal device 110 may switch from one cell to another cell under control of the same CU and same DU. For example, the terminal device 110 may be handed over from one cell 161 to another cell 162. This is called as an intra-CU intra-DU serving cell change. In some embodiments, the terminal device 110 may switch from one cell to another cell under control of the same CU and different DUs. For example, the terminal device 110 may be handed over from one cell 161 to another cell 164. In this case, a cell change from one cell of DU 151 to another cell of DU 152 will occur. This is called as an intra-CU inter-DU serving cell change. In another example, the terminal device 110 may be handed over from a cell of one DU to a cell of another DU under control of different CUs. In this case, a handover from a CU to another CU will occur. This is called as an inter-CU handover.

The network device 120 and the network device 130 may correspond to one or two devices under the same CU. In some embodiments, a CU and a DU may be implemented in separate devices. In some embodiments, a CU and a DU may be implemented in the same device. In some embodiments, different DUs may be implemented in separate devices.

Return to FIG. 1A, in some embodiments, the terminal device 110 may be located within the coverage of cell 121 of the network device 120, and the terminal device 110 may communicate with the network device 120 based on network configuration. In this case, the cell 121 may be referred to as a serving cell of the terminal device 110.

In some embodiments, the terminal device 110 may establish a dual connection (i.e., simultaneous connection) with the network device 120 and another network device (not shown). In some embodiments, the network device 120 may serve as a master node (MN). In these embodiments, the terminal device 110 may communicate with the network device 120 via a set of serving cells. The set of serving cells form a MCG, and a primary cell in the MCG is called as PCell. In some scenarios, the PCell may be changed from the cell 121 to the cell 131. This is called as a handover. In some embodiments, the network device 120 may serve as a secondary node (SN). In these embodiments, the set of serving cells provided by the network device 120 form a SCG, and a primary cell in the SCG is called as PSCell. In some scenarios, the PSCell may be changed from the cell 121 to the cell 131. This is called as a PScell change.

In some scenarios, the terminal device 110 may receive, from the network device 120, a L1 or L2 signaling indicating an addition or change or release of a serving cell. Upon the addition or change or release of the serving cell, the terminal device 110 may perform a data transmission with an addition, modification or change of the serving cell. This procedure is called as the L1/L2 based mobility.

FIG. 1E illustrates a schematic diagram illustrating a process 100E of L1/L2 based mobility in which some embodiments of the present disclosure can be implemented. For the purpose of discussion, the process 100E will be described with reference to FIG. 1A. The process 100E may involve the terminal device 110 and the network device 120 as illustrated in FIG. 1A. The network device 120 may be a MN or SN serving the terminal device 110. In this example, the network device 120 provides a serving cell for the terminal device 110. The network device 130 does not provide a serving cell for the terminal device 110.

As shown in FIG. 1E, the network device 120 may transmit 170, to the terminal device 110, a RRC reconfiguration comprising a set of RRC configurations corresponding to a set of candidate cells allowing L1/L2 based mobility. The network device 120 may also transmit 171, to the terminal device 110, a configuration of beams (for example, a synchronization signal and physical broadcast channel block (SSB) or a channel state information-reference signal (CSI-RS)) of a candidate cell for L1 measurement.

The terminal device 110 may perform 172 the L1 measurement based on the configuration. If a certain condition is fulfilled by a beam, e.g., quality of the beam is above threshold quality, the terminal device 110 may report 173 an indication of the beam (e.g., an identity (ID) associated with the beam) to the network device 120.

The network device 120 may transmit 174, to the terminal device 110, a L1/L2 signaling (e.g., downlink control information (DCI) or a medium access control (MAC) control element (CE)). The L1/L2 signaling indicates that TCI state(s) for a cell among candidate cells are activated along with a cell change or addition.

Upon reception of the L1/L2 signaling, the terminal device 110 may perform 175 the cell change or addition. For example, the lower layer (e.g., PHY or MAC layer) of the terminal device 110 indicates, to the RRC layer of the terminal device 110, information of the cell change or addition, e.g. an ID associated with the target cell. Upon reception of the indication, the RRC layer performs the cell change or addition by applying the RRC configuration corresponding to the target cell. The target cell may be PCell, PSCell or SCell of the terminal device 110. And the terminal device 110 may start a data transmission with the target cell using a pre-configured UE-dedicated channel and the activated TCI states.

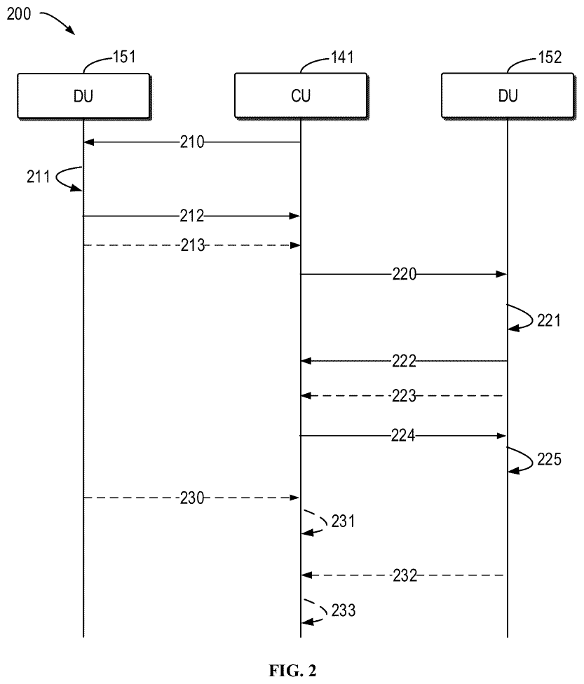

Embodiments of the present disclosure provide solutions of CU-DU interface signaling to support a L1/L2 based mobility procedure. Their details will be described with reference to FIGS. 2 to 4C.

### Example Implementation of CU-DU Signaling for Candidate Cell Configuration

FIG. 2 illustrates a schematic diagram illustrating a process 200 of a candidate cell configuration for L1/L2 based mobility according to embodiments of the present disclosure. For the purpose of discussion, the process 200 will be described with reference to FIG. 1D. The process 200 may involve the CU 141 and the DUs 151 and 152 as illustrated in FIG. 1D. In this example, the DU 151 serves the terminal device 110, and the DU 152 does not serve the terminal device 110. That is, the DU 151 serves as a source DU. The DU 152 serves as a candidate (i.e., a candidate DU) of a target DU.

### CU-Initiated Configuration for Intra-DU Scenario

As shown in FIG. 2, the CU 141 may transmit 210, to a source DU (e.g., the DU 151), a message (for convenience, also referred to as a first message herein) for initializing, modifying or cancelling of a configuration for a lower-layer signaling based cell change or addition (i.e., L1/L2 based mobility). For example, the first message may be a UE context modification request message. It is to be understood that this is merely an example, and any other suitable messages are also feasible.

In some embodiments, the first message may comprise first L1/L2 based mobility information (also referred as information L1/L2 based intra-DU mobility information). In some embodiments, the first L1/L2 based mobility information may comprise an indication of the initialization, modification or cancellation of the configuration for L1/L2 based mobility. In other words, the indication indicates whether the first message concerns an initialization of L1/L2 based mobility, a modification of L1/L2 based mobility, or a cancellation of L1/L2 based mobility. In some embodiments, the first message may comprise ID information of a set of candidate cells of the DU 151 for L1/L2 based mobility. For example, the ID information may comprise a cell global ID (CGI). It is to be understood that any other suitable ID information is also feasible. In some embodiments, the first L1/L2 based mobility information may comprise ID information of a set of candidate cells to be cancelled for L1/L2 based mobility. In some embodiments, the set of candidate cells may comprise a candidate cell. In some embodiments, the candidate cell can be a candidate SpCell. In some embodiments, the candidate cell can be a candidate SCell. In some embodiments, the set of candidate cells may comprise multiple candidate cells. In some embodiments, the set of candidate cells may comprise a set of candidate SpCells. In some embodiments, the set of candidate cells may comprise a set of candidate SCells. In some embodiments, the first L1/L2 based mobility information comprises a list of IDs of candidate cells to be cancelled. It is also to be understood that the first message may comprise any other suitable information or combination of information.

Upon reception of the first message, the DU 151 may modify 211 a context of the terminal device 110 (i.e., UE context). If the DU 151 succeeds to modify the UE context, the DU 151 may transmit 212, to the CU 141, a positive response to the first message. For example, the DU 151 may transmit a UE context modification response message to the CU 141. Of course, the positive response may also adopt any other suitable messages.

In some embodiments, if the first message concerns an initialization of L1/L2 based mobility and comprises ID information of the set of candidate cells of the DU 151 for L1/L2 based mobility, the DU 151 may cause the ID information of the set of candidate cells of the DU 151 to be comprised in the positive response. In some alternative embodiments where the first message does not comprise ID information of a set of candidate cells of the DU 151 for L1/L2 based mobility, the DU 151 may determine a set of candidate cells of the DU 151 by itself, and transmit, to the CU 141 and in the positive response, ID information of the set of candidate cells of the DU 151.

In some embodiments, if the first message concerns a modification of L1/L2 based mobility, the DU 151 may replace existing prepared L1/L2 based mobility identified by an ID of the terminal device 110 (for example, gNB-DU UE F1AP ID) and an ID of the set of candidate cell of DU 151 for L1/L2 based mobility provided in the first message.

In some embodiments, if the first message concerns a cancellation of L1/L2 based mobility, the DU 151 may consider that the CU 141 is to remove any configuration, and release any resources previously reserved for a candidate cell associated with terminal device 110 associated signaling identified by IDs of the terminal device 110 (for example, gNB-CU UE F1AP ID and the gNB-DU UE F1AP ID). In some embodiments, if the first message comprises the list of IDs of candidate cells to be cancelled, the DU 151 may consider that only resources reserved for cells identified by the list of IDs are to be released by the CU 141.

Continue to refer to FIG. 2, if the DU 151 does not modify the UE context successfully, the DU 151 may transmit 213, to the CU 141, a negative response to the first message. For example, the DU 151 may transmit a UE context modification failure message to the CU 141. Of course, the negative response may also adopt any other suitable messages.

In some embodiments where the first message comprises ID information of a set of candidate cells of the DU 151 for L1/L2 based mobility, the DU 151 may cause the ID information of the set of candidate cells of the DU 151 to be comprised in the negative response.

In this way, a CU-initiated configuration and management of L1/L2 based mobility information is achieved for an intra-DU scenario.

### CU-Initiated Configuration for Inter-DU Scenario

Still with reference to FIG. 2, the CU 141 may transmit 220, to a candidate DU (e.g., the DU 152), a message (for convenience, also referred to as a third message herein) for initializing or modifying of a configuration for a lower-layer signaling based cell change or addition (i.e., L1/L2 based mobility). For example, the third message may be a UE context setup request message. It is to be understood that this is merely an example, and any other suitable messages are also feasible.

In some embodiments, the third message may comprise a second L1/L2 based mobility information (also referred as information L1/L2 based inter-DU mobility information). In some embodiments, the second L1/L2 based inter-DU mobility information may comprise an indication of the initialization or modification of the configuration for L1/L2 based mobility. In other words, the indication indicates whether the third message concerns an initialization of L1/L2 based mobility or a modification of L1/L2 based mobility. In some embodiments, the second L1/L2 based inter-DU mobility information may comprise ID information of a set of candidate cells of the DU 152 for L1/L2 based mobility. For example, the ID information may comprise a cell global ID (CGI). It is to be understood that any other suitable ID information is also feasible. In some embodiments, second L1/L2 based inter-DU mobility information may comprise ID information of the terminal device 110. For example, the ID information may comprise a target gNB-DU UE F1AP ID. It is to be understood that any other suitable ID information is also feasible. In some embodiments, the set of candidate cells may comprise a candidate cell. In some embodiments, the candidate cell can be a candidate SpCell, In some embodiments, the candidate cell can be a candidate SCell. In some embodiments, the set of candidate cells may comprise multiple candidate cells. In some embodiments, the set of candidate cells may comprise a set of candidate SpCells. In some embodiments, the set of candidate cells may comprise a set of candidate SCells. It is also to be understood that the third message may comprise any other suitable information or combination of information.

Upon reception of the third message, the DU 152 may establish 221 a context of the terminal device 110 (i.e., UE context). If the DU 152 succeeds to establish the UE context, the DU 152 may transmit 222, to the CU 141, a positive response to the third message. For example, the DU 152 may transmit a UE context setup response message to the CU 141. Of course, the positive response may also adopt any other suitable messages.

In some embodiments, if the third message concerns an initialization of L1/L2 based mobility and comprises ID information of a set of candidate cells of the DU 152 for L1/L2 based mobility, the DU 152 may cause the ID information of the set of candidate cells of the DU 152 to be comprised in the positive response. In some alternative embodiments where the third message does not comprise ID information of a set of candidate cells of the DU 152 for L1/L2 based mobility, the DU 152 may determine a set of candidate cells of the DU 152 by itself, and transmit, to the CU 141 and in the positive response, ID information of the set of candidate cells of the DU 152.

In some embodiments, if the third message concerns a modification of L1/L2 based mobility, the DU 152 may replace existing prepared L1/L2 based mobility identified by the ID information of the terminal device 110 (for example, the target gNB-DU UE F1AP ID) and the ID information of a set of candidate cells of the DU 152.

Continue to refer to FIG. 2, if the DU 152 does not establish the UE context successfully, the DU 152 may transmit 223, to the CU 141, a negative response to the third message. For example, the DU 151 may transmit a UE context setup failure message to the CU 141. Of course, the negative response may also adopt any other suitable messages.

In some embodiments where the third message comprises ID information of a set of candidate cells of the DU 152 for L1/L2 based mobility, the DU 152 may cause the ID information of the set of candidate cells of the DU 152 to be comprised in the negative response.

In this way, a CU-initiated initialization and modification of L1/L2 based mobility information is achieved for an inter-DU scenario.

Still refer to FIG. 2, the CU 141 may transmit 224, to a candidate DU (e.g., the DU 152), a message (for convenience, also referred to as a fourth message herein) indicating a cancellation of a configuration for L1/L2 based mobility. In some embodiments, the fourth message may be a UE context release command message. It is to be understood that this is merely an example, and any other suitable messages are also feasible. The DU 152 may send an acknowledgement message to the CU 141. In some embodiments, the acknowledgement message may be a UE context release complete message.

In some embodiments, the fourth message may comprise ID information of a set of candidate cells of the DU 152 to be cancelled for L1/L2 based mobility. For example, the ID information may comprise a CGI. It is to be understood that any other suitable ID information is also feasible. In some embodiments, the set of candidate cells may comprise a candidate cell. In some embodiments, the candidate cell may be a candidate SpCells. In some embodiments, the candidate cell may be a candidate SCell. In some embodiments, the set of candidate cells may comprise multiple candidate cells. In some embodiments, the set of candidate cells may comprise a set of candidate SpCells. In some embodiments, the set of candidate cells may comprise a set of candidate SCells. It is also to be understood that the fourth message may comprise any other suitable information or combination of information.

Upon reception of the fourth message, the DU 152 may consider 225 that the CU 141 is cancelling only L1/L2 based mobility associated to the cells identified by the ID information of the set of candidate cells of the DU 152 to be cancelled and associated to the terminal device associated signaling identified by IDs of the terminal device 110 (e.g. gNB-CU UE F1AP ID and gNB-DU UE F1AP ID).

In this way, a CU-initiated cancellation of L1/L2 based mobility information is achieved for an inter-DU scenario.

Alternatively, a cancellation of L1/L2 based mobility information may also be initiated by DU for an inter-DU or intra DU scenario. For convenience, this will be described still in connection with FIG. 2.

With reference to FIG. 2, the DU 151 may transmit 230, to the CU 141, a message (for convenience, also referred to as a second message herein) for requesting a cancellation of a configuration for L1/L2 based mobility. For example, the second message may be a UE context modification required message. It is to be understood that this is merely an example, and any other suitable messages are also feasible. The DU 151 may send an acknowledgement message to the CU 141. In some embodiments, the acknowledgement message can be UE context modification confirm message.

In some embodiments, the second message may comprise ID information of a set of candidate cells of the DU 151 to be cancelled for L1/L2 based mobility. For example, the ID information may comprise a CGI. It is to be understood that any other suitable ID information is also feasible. In some embodiments, the set of candidate cells may comprise a candidate cell. In some embodiments, the candidate cell can be a candidate SpCells. In some embodiments, the candidate cell can be a candidate SCell. In some embodiments, the set of candidate cells may comprise multiple candidate cells. In some embodiments, the set of candidate cells may comprise a set of candidate SpCells. In some embodiments, the set of candidate cells may comprise a set of candidate SCells. It is also to be understood that the second message may comprise any other suitable information or combination of information.

Upon reception of the second message, the CU 141 may consider 231 that only resources reserved for candidate cells identified by the ID information of the set of candidate cells of the DU 151 to be cancelled and associated with the terminal device associated signaling identified by IDs of the terminal device 110 (e.g. gNB-CU UE F1AP ID and a gNB-CU UE F1AP ID) are to be released by the DU 151.

In this way, a DU-initiated cancellation of L1/L2 based mobility information is achieved for an intra DU scenario.

Still with reference to FIG. 2, the DU 152 may transmit 232, to the CU 141, a message (for convenience, also referred to as a fifth message herein) for requesting a cancellation of a configuration for L1/L2 based mobility. For example, the fifth message may be a UE context release request message. It is to be understood that this is merely an example, and any other suitable messages are also feasible.

In some embodiments, the fifth message may comprise ID information of a set of candidate cells of the DU 152 to be cancelled for L1/L2 based mobility. For example, the ID information may comprise a CGI. It is to be understood that any other suitable ID information is also feasible. In some embodiments, the set of candidate cells may comprise a candidate cell. In some embodiments, the candidate cell may be a candidate SpCells. In some embodiments, the candidate cell may be a candidate SCell. In some embodiments, the set of candidate cells may comprise multiple candidate cells. In some embodiments, the set of candidate cells may comprise a set of candidate SpCells. In some embodiments, the set of candidate cells may comprise a set of candidate SCells. It is also to be understood that the second message may comprise any other suitable information or combination of information.

Upon reception of the fifth message, the CU 141 may consider 233 that only resources reserved for candidate cells identified by the ID information of the set of candidate cells of the DU 152 to be cancelled and associated with the terminal device associated signaling identified by IDs of the terminal device 110 (e.g., gNB-CU UE F1AP ID and a gNB-CU UE F1AP ID) are to be released by the DU 152.

In this way, a DU-initiated cancellation of L1/L2 based mobility information is achieved for an inter DU scenario.

### Example Implementation of CU-DU Signaling for Lower-Layer Measurement Configuration

Traditionally, L1 measurement and reporting configuration for serving cells of a DU is generated by the DU, and it is transparent to a CU. For L1/L2 based mobility, UE is required to perform a lower layer measurement for beams of non-serving cells belonging to multiple DUs, and report measurement results to the current serving DU of the UE. However, how to enable UE to perform beam measurement for candidate cells belonging to non-serving DUs is still unclear.

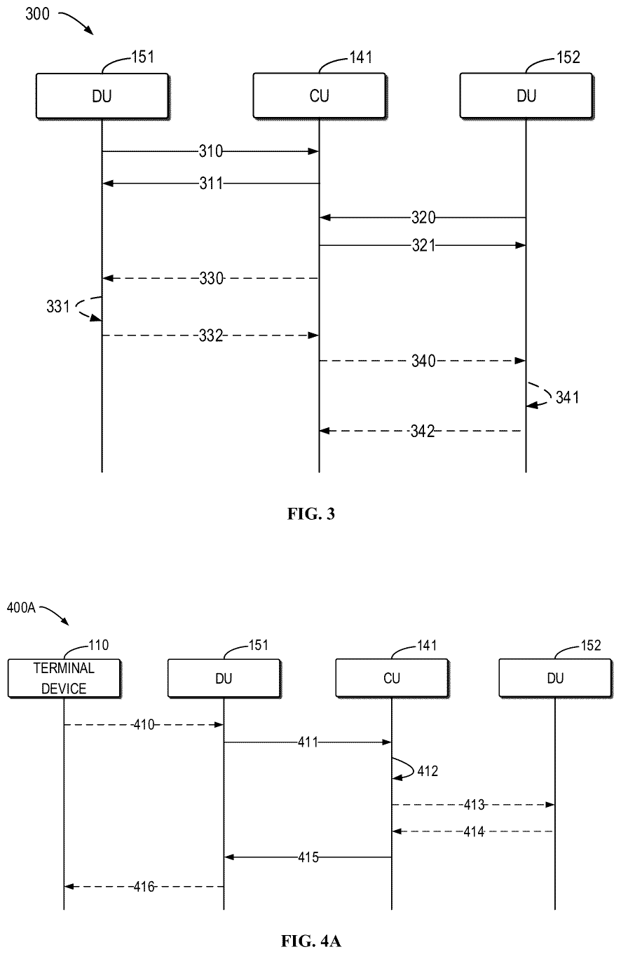

In view of this, embodiments of the present disclosure provide solutions of a lower-layer measurement configuration for L1/L2 based mobility. This will be described below in connection with FIG. 3.

FIG. 3 illustrates a schematic diagram illustrating a process 300 of a lower-layer measurement configuration for L1/L2 based mobility according to embodiments of the present disclosure. For the purpose of discussion, the process 300 will be described with reference to FIG. 1D. The process 300 may involve the CU 141 and the DUs 151 and 152 as illustrated in FIG. 1D. In this example, the DU 151 serves the terminal device 110, and the DU 152 does not serve the terminal device 110. That is, the DU 151 serves as a source DU. The DU 152 serves as a candidate (i.e., candidate DU) of a target DU.

CU Forwarding Configurations among DUs

As shown in FIG. 3, in some embodiments, the DU 151 may transmit 310, to the CU 141, a configuration (for convenience, also referred to as a first configuration herein) for a lower-layer measurement and report for a set of candidate cells of the DU 151.

For example, for intra-DU mobility case, the DU 151 may send, to the CU 141, a L1 measurement and reporting configuration of candidate cells of the DU 151 in UE context modification request response message. It is to be understood that any other suitable messages existing or to be developed are also feasible.

Then the CU 141 may transmit 311 the first configuration to at least one candidate DU (for example, the DU 152). For example, the CU 141 may transmit the L1 measurement and reporting configuration of the DU 151 to the DU 152 by a UE context setup request message. It is to be understood that any other suitable messages existing or to be developed are also feasible.

In some embodiments, a candidate DU (for example, the DU 152) may transmit 320, to the CU 141, a configuration (for convenience, also referred to as a second configuration herein) for a lower-layer measurement and report for a set of candidate cells of the DU 152.

For example, for inter-DU mobility case, the DU 152 may send, to the CU 141, a L1 measurement and reporting configuration of candidate cells of the DU 152 in a UE context setup request response message. It is to be understood that any other suitable messages existing or to be developed are also feasible.

Then the CU 141 may transmit 321 the second configuration to a source DU (e.g., the DU 151) and other candidate DUs. For example, the CU 141 may transmit the L1 measurement and reporting configuration of the DU 152 to the DU 151 by a UE context modification request message. It is to be understood that any other suitable messages existing or to be developed are also feasible. For another example, the CU 141 may transmit the L1 measurement and reporting configuration of the DU 152 to other candidate DUs by a UE context setup request message.

In this way, L1 measurement and reporting configuration for candidate cells of non-serving DUs may be enabled.

### CU Sending Information of DUs

As an alternative, a CU may transmit, to each DU, information of candidate cells of other DUs, such that each DU can generate lower layer measurement and report configuration for candidate cells of other DUs. For convenience, this will be described below still in connection with FIG. 3.

With reference to FIG. 3, the CU 140 may transmit 330, to the DU 151, information of a set of candidate cells of at least one candidate DU (for example, the DU 152). For example, the CU 141 may send, to the DU 151, information of candidate cells in the DU 152 in a UE context modification request message. It is to be understood that any other suitable messages existing or to be developed are also feasible.

Based on the received information of candidate cells in the DU 152, the DU 151 may generate 331 a configuration (for convenience, also referred to as a third configuration herein) for a lower-layer measurement and report for the set of candidate cells of the at least one candidate DU. Then the DU 151 may transmit 332 the third configuration to the CU 141.

Continue to refer to FIG. 3, the CU 140 may also transmit 340, to the DU 152, information of a set of candidate cells of a source DU (for example, the DU 151) and other candidate DUs. For example, the CU 141 may send, to the DU 152, information of candidate cells in the DU 151 in a UE context setup request message. It is to be understood that any other suitable messages existing or to be developed are also feasible.

Based on the received information of candidate cells in the DU 151 and other candidate DUs, the DU 152 may generate 341 a configuration (for convenience, also referred to as a fourth configuration herein) for a lower-layer measurement and report for the set of candidate cells of the DU 151 and other candidate DUs. Then the DU 152 may transmit 342 the fourth configuration to the CU 141.

In this way, L1 measurement and reporting configuration for candidate cells of non-serving DUs may also be enabled.

### Example Implementation of CU-DU Signaling for Exacution of L1/L2 Based Mobility

For a traditional handover (HO) procedure, a CU sends a target cell ID to a DU, since the traditional HO procedure is based on L3 measurement report and the CU receives the L3 measurement results from UE. However, for L1/L2 based mobility, it is a source DU who receives the L1/L2 measurement report. Then the issue would be which node makes decision on L1/L2 based mobility, and which information needs to be exchanged between the nodes.

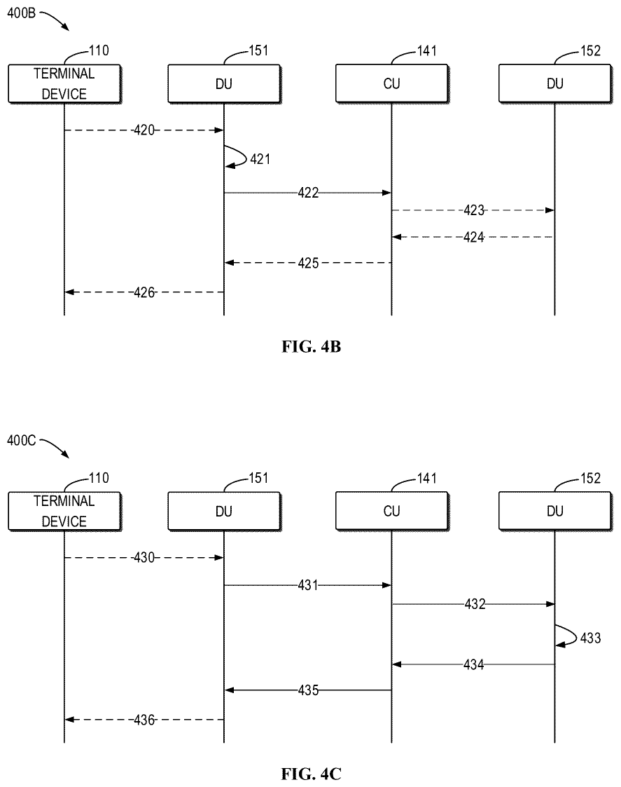

In view of this, embodiments of the present disclosure provide solutions for execution of L1/L2 based mobility. For illustration, these solutions will be described in connection with FIGS. 4A to 4C.

### CU Making Decision

FIG. 4A illustrates a schematic diagram illustrating a process 400A of triggering a L1/L2 based mobility according to embodiments of the present disclosure. For the purpose of discussion, the process 400A will be described with reference to FIG. 1D. The process 400A may involve the CU 141 and the DUs 151 and 152 as illustrated in FIG. 1D. In this example, the DU 151 serves the terminal device 110, and the DU 152 does not serve the terminal device 110. That is, the DU 151 serves as a source DU. The DU 152 serves as a candidate (i.e., candidate DU) of a target DU.

As shown in FIG. 4A, the terminal device 110 may transmit 410 a lower-layer measurement report to the DU 151.

Upon reception of the lower-layer measurement report, the DU 151 may transmit 411, to the CU 141, information (for convenience, also referred to as first information or assistance information herein) regarding at least one candidate cell for a lower-layer signaling based cell change or addition (i.e., L1/L2 based mobility).

In some embodiments, the assistance information may be transmitted by F1 message. In some embodiments, the assistance information may comprise ID information of the at least one candidate cell. For example, the assistance information may comprise CGI of one or more suggested SpCell or SCell. In some embodiments, the assistance information may comprise reference signal (RS) or transmission configuration indicator (TCI) information of the at least one candidate cell. For example, the assistance information may comprise an index of RS or TCI state. In some embodiments, the RS can be SSB. In some embodiments, the RS can be a CSI-RS. In some embodiments, the assistance information may comprise measurement results of the at least one candidate cell. For example, the assistance information may comprise reference signal receive power (RSRP) or other measurement results of the suggested candidate cell and other candidate cells. It is to be understood that the assistance information may also comprise any other suitable information or combination of information.

Based on the assistance information, the CU 141 may determine 412 a target cell (also referred as selected candidate cell herein) for the L1/L2 based mobility. In this way, a CU makes decision on a target cell for L1/L2 based mobility.

It is assumed that the DU 152 serves as a target DU providing the target cell. In some embodiments for inter-DU mobility, the CU 141 may transmit 413, to the DU 152, an indication indicating that the L1/L2 based mobility is to be triggered for the target cell of the DU 152. In some embodiments, the indication may comprise ID information of the target cell. For example, the indication may comprise CGI of the target SpCell or SCell. In some embodiments, the indication may comprise RS or TCI information of the target cell. For example, the assistance information may comprise an index of RS or TCI state. In some embodiments, the RS can be a SSB. In some embodiments, the RS can be CSI-RS. It is to be noted that the indication may comprise any other suitable information or combination of information.

Upon reception of the indication, the DU 152 may transmit 414, to the CU 141, an acknowledgement for the triggering of the L1/L2 based mobility. In some embodiments, the acknowledgement may comprise a dedicated random access (RA) configuration (also referred to as contention free RA configuration) for the L1/L2 based mobility. In some embodiments, the acknowledgement may comprise a configuration of timing advance (TA) for the target cell, for example the TA value for the target cell. It is to be noted that the acknowledgement may comprise any other suitable information or combination of information.

The CU 141 may transmit 415, to the DU 151, information (for convenience, also referred to as second information herein) regarding the target cell for the L1/L2 based mobility. In some embodiments for intra-DU mobility, the second information may comprise at least one of the following: ID information of the target cell, or RS or TCI information of the target cell. For example, the indication may comprise CGI of the target SpCell or SCell. For example, the assistance information may comprise an index of RS or TCI state. In some embodiments, the RS can be SSB. In some embodiments, the RS can be CSI-RS. In some embodiments for inter-DU mobility, the second information may further comprise at least one of the following: a dedicated RA configuration for the L1/L2 based mobility, or a configuration of TA for the target cell. It is to be noted that these are merely examples and the second information may also comprise any other suitable information or combination of information.

Based on the second information, the DU 151 may transmit 416, to the terminal device 110, a lower-layer signaling (i.e., L1/L2 signaling) to trigger the L1/L2 based mobility.

In this way, a CU may have overall control of a L1/L2 based mobility procedure.

### Source DU Making Decision

FIG. 4B illustrates a schematic diagram illustrating a process 400B of triggering a L1/L2 based mobility according to embodiments of the present disclosure. For the purpose of discussion, the process 400B will be described with reference to FIG. 1D. The process 400B may involve the CU 141 and the DUs 151 and 152 as illustrated in FIG. 1D. In this example, the DU 151 serves the terminal device 110, and the DU 152 does not serve the terminal device 110. That is, the DU 151 serves as a source DU. The DU 152 serves as a candidate (i.e., candidate DU) of a target DU.

As shown in FIG. 4B, the terminal device 110 may transmit 420 a lower-layer measurement report to the DU 151.

Upon reception of the lower-layer measurement report, the DU 151 may determine 421 a target cell (also referred as selected candidate cell) for the L1/L2 based mobility. In this way, a source DU makes decision on a target cell for L1/L2 based mobility.

The DU 151 may transmit 422, to the CU 141, information (for convenience, also referred to as third information herein) indicating that L1/L2 based mobility is triggered for the target cell. For example, the third information may be an access success message. Of course, other existing messages ore newly defined messages are not precluded.

In some embodiments, the third information may be transmitted by F1 message. For example, the F1 message may be an access success message or any other suitable messages. In some embodiments, the third information may comprise ID information of the target cell. For example, the third information may comprise CGI of the target cell such as a SpCell or SCell. In some embodiments, the third information may comprise RS or TCI information of the target cell. For example, the third information may comprise an index of RS or TCI state. In some embodiments, the RS may be a SSB. In some embodiments, the RS may be a CSI-RS. It is to be understood that the third information may also comprise any other suitable information or combination of information.

It is assumed that the DU 152 serves as a target DU providing the target cell. In some embodiments for inter-DU mobility, the CU 141 may transmit 423, to the DU 152, an indication indicating that the L1/L2 based mobility is to be triggered for the target cell of the DU 152. In some embodiments, the indication may comprise ID information of the target cell. For example, the third information may comprise CGI of the target cell such as a SpCell or SCell. In some embodiments, the indication may comprise RS or TCI information of the target cell. For example, the third information may comprise an index of RS or TCI state. In some embodiments, the RS may be a SSB. In some embodiments, the RS may be a CSI-RS. It is to be noted that the indication may comprise any other suitable information or combination of information.

Upon reception of the indication, the DU 152 may transmit 424, to the CU 141, an acknowledgement for the triggering of the L1/L2 based mobility. In some embodiments, the acknowledgement may comprise a dedicated RA configuration for the L1/L2 based mobility. In some embodiments, the acknowledgement may comprise a configuration of TA for the target cell, for example, the TA value for the target cell. It is to be noted that the acknowledgement may comprise any other suitable information or combination of information.

The CU 141 may transmit 425, to the DU 151, information (for convenience, also referred to as fourth information herein) regarding the target cell for the L1/L2 based mobility. In some embodiments for inter-DU mobility, the fourth information may comprise at least one of the following: a dedicated RA configuration for the L1/L2 based mobility, or a configuration of TA for the target cell. It is to be noted that these are merely examples and the fourth information may also comprise any other suitable information or combination of information.

The DU 151 may transmit 426, to the terminal device 110, a lower-layer signaling (i.e., L1/L2 signaling) to trigger the L1/L2 based mobility. In some embodiments for inter-DU mobility, the DU 151 may transmit the lower-layer signaling comprising the fourth information.

In this way, a DU may make decision directly on a target cell and inform the decision to a CU. Thus, latency over F1 interface due to message exchange between a CU and a DU may be avoided.

### Candidate DU Making Decision

FIG. 4C illustrates a schematic diagram illustrating a process 400C of triggering a L1/L2 based mobility according to embodiments of the present disclosure. For the purpose of discussion, the process 400C will be described with reference to FIG. 1D. The process 400C may involve the CU 141 and the DUs 151 and 152 as illustrated in FIG. 1D. In this example, the DU 151 serves the terminal device 110, and the DU 152 does not serve the terminal device 110. That is, the DU 151 serves as a source DU. The DU 152 serves as a candidate (i.e., candidate DU) of a target DU.

As shown in FIG. 4C, the terminal device 110 may transmit 430 a lower-layer measurement report to the DU 151.

Upon reception of the lower-layer measurement report, the DU 151 may transmit 431, to the CU 141, information (for convenience, also referred to as fifth information herein) regarding at least one candidate cell for a lower-layer signaling based cell change or addition (i.e., L1/L2 based mobility).

In some embodiments, the fifth information may be transmitted by F1 message. In some embodiments, the fifth information may comprise ID information of the at least one candidate cell. For example, the fifth information may comprise CGI of one or more suggested SpCell or SCell. In some embodiments, the fifth information may comprise RS or TCI information of the at least one candidate cell. For example, the fifth information may comprise an index of RS or TCI state. In some embodiments, the RS may be a SSB. In some embodiments, the RS may be a CSI-RS. In some embodiments, the fifth information may comprise measurement results of the at least one candidate cell. For example, the fifth information may comprise RSRP or other measurement results of a suggested candidate cell and other candidate cells. It is to be understood that the fifth information may also comprise any other suitable information or combination of information.

The CU 141 may forward 432 the fifth information to the DU 152. The DU 152 may determine 433 a target cell (also referred as selected candidate cell herein) for the L1/L2 based mobility based on the fifth information. In this way, a candidate DU makes decision on a target cell for L1/L2 based mobility.

It is assumed that the DU 152 decides to trigger the L1/L2 based mobility on one of candidate cells of the DU 152. In these embodiments, the DU 152 may transmit 434, to the CU 141, information (for convenience, also referred to as sixth information herein) regarding the target cell for the L1/L2 based mobility. In some embodiments, the sixth information may comprise ID information of the target cell. In some embodiments, the sixth information may comprise RS or TCI information of the target cell. In some embodiments, the RS may be a SSB. In some embodiments, the RS may be a CSI-RS. In some embodiments, the sixth information may comprise a dedicated RA configuration for the L1/L2 based mobility. In some embodiments, the sixth information may comprise a configuration of TA for the target cell. It is to be noted that these are merely examples and the sixth information may also comprise any other suitable information or combination of information.

The CU 141 may forward 435 the sixth information to the DU 151. Based on the sixth information, the DU 151 may transmit 436, to the terminal device 110, a lower-layer signaling (i.e., L1/L2 signaling) to trigger the L1/L2 based mobility.

In this way, a candidate DU may decide whether to trigger L1/L2 based mobility based on the latest situation of the candidate DU.

### Example Implementation of Methods

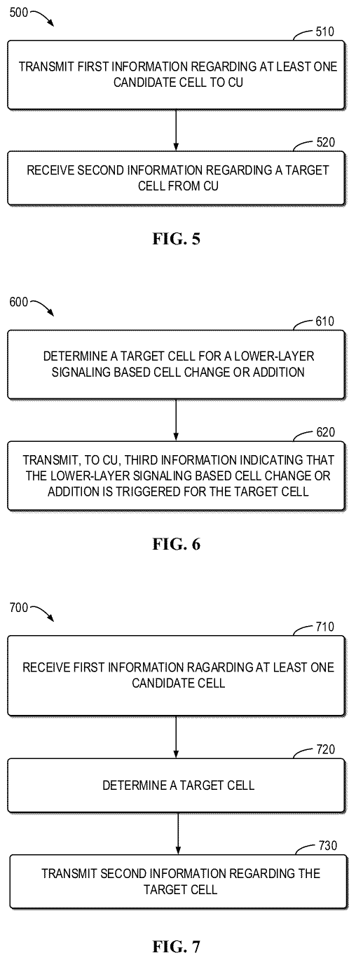

Accordingly, embodiments of the present disclosure provide methods of communication implemented at a terminal device and a network device. These methods will be described below with reference to FIGS. 5 to 9.

FIG. 5 illustrates an example method 500 of communication implemented at a first DU as a source DU in accordance with some embodiments of the present disclosure. For example, the method 500 may be performed at the DU 151 as shown in FIG. 1D. For the purpose of discussion, in the following, the method 500 will be described with reference to FIG. 1D. It is to be understood that the method 500 may include additional blocks not shown and/or may omit some blocks as shown, and the scope of the present disclosure is not limited in this regard. In this example, the DU 151 serves the terminal device 110, and the DU 152 does not serve the terminal device 110. That is, the DU 151 serves as a source DU. The DU 152 serves as a candidate (i.e., candidate DU) of a target DU.

At block 510, the DU 151 transmits, to the CU 141, first information regarding at least one candidate cell for a lower-layer signaling based cell change or addition. In some embodiments, the first information may comprise at least one of the following: ID information of the at least one candidate cell, RS or TCI information of the at least one candidate cell, or measurement results of the at least one candidate cell.

At block 520, the DU 151 receives, from the CU 141, second information regarding a target cell for the lower-layer signaling based cell change or addition. In some embodiments, the second information may comprise at least one of the following: identity information of the target cell, RS or TCI information of the target cell, a dedicated RA configuration for the cell change or addition, or a configuration of TA for the target cell.

In some embodiments, the DU 151 may receive, from the CU 141, a first message indicating an initialization, modification or cancellation of a configuration for the lower-layer signaling based cell change or addition. If a context of a terminal device (for example, the terminal device 110) is modified successfully based on the first message, the DU 151 may transmit a positive response to the first message. If the context of the terminal device 110 is not modified successfully based on the first message, the DU 151 may transmit a negative response to the first message.

In some embodiments, the first message may comprise at least one of the following: an indication of the initialization, modification or cancellation of the configuration for the lower-layer signaling based cell change or addition; ID information of a set of candidate cells of the DU 151 for the lower-layer signaling based cell change or addition; or ID information of a set of candidate cells to be cancelled for the lower-layer signaling based cell change or addition.

In some embodiments where the first message indicates the initialization of the configuration, the DU 151 may determine a set of candidate cells of the DU 151 for the lower-layer signaling based cell change or addition, and transmit, to the CU and in the positive response, ID information of the set of candidate cells of the DU 151.

In some embodiments, the DU 151 may transmit, to the CU 141, a second message for requesting a cancellation of a configuration for the lower-layer signaling based cell change or addition.

In some embodiments, the DU 151 may transmit, to the CU 141, a first configuration for a lower-layer measurement and report for a set of candidate cells of the first DU, and receive, from the CU 141, a second configuration for a lower-layer measurement and report for a set of candidate cells of at least one candidate DU.

In some embodiments, the DU 151 may receive, from the CU 141, information of a set of candidate cells of at least one candidate DU, and generate a third configuration for a lower-layer measurement and report for the set of candidate cells of the at least one candidate DU. Then the DU 151 may transmit the third configuration to the CU 141.

With the method 500, a DU may provide assistance information to a CU and help the CU to control a L1/L2 based mobility procedure.

FIG. 6 illustrates another example method 600 of communication implemented at a first DU as a source DU in accordance with some embodiments of the present disclosure. For example, the method 600 may be performed at the DU 151 as shown in FIG. 1D. For the purpose of discussion, in the following, the method 600 will be described with reference to FIG. 1D. It is to be understood that the method 600 may include additional blocks not shown and/or may omit some blocks as shown, and the scope of the present disclosure is not limited in this regard. In this example, the DU 151 serves the terminal device 110, and the DU 152 does not serve the terminal device 110. That is, the DU 151 serves as a source DU. The DU 152 serves as a candidate (i.e., candidate DU) of a target DU.

At block 610, the DU 151 determines a target cell for a lower-layer signaling based cell change or addition.

At block 620, the DU 151 transmits, to the CU 141, third information indicating that the lower-layer signaling based cell change or addition is triggered for the target cell.

In some embodiments, the third information may comprise at least one of the following: ID information of the target cell, or RS or TCI information of the target cell.

In some embodiments, the DU 151 may receive, from the CU 141, fourth information regarding the target cell for the lower-layer signaling based cell change or addition. In some embodiments, the fourth information may comprise at least one of the following: a dedicated RA configuration for the lower-layer signaling based cell change or addition, or a configuration of TA for the target cell.

In some embodiments, the DU 151 may receive, from the CU 141, a first message indicating an initialization, modification or cancellation of a configuration for the lower-layer signaling based cell change or addition. If a context of a terminal device (for example, the terminal device 110) is modified successfully based on the first message, the DU 151 may transmit a positive response to the first message. If the context of the terminal device 110 is not modified successfully based on the first message, the DU 151 may transmit a negative response to the first message.

In some embodiments, the first message may comprise at least one of the following: an indication of the initialization, modification or cancellation of the configuration for the lower-layer signaling based cell change or addition; ID information of a set of candidate cells of the DU 151 for the lower-layer signaling based cell change or addition; or ID information of a set of candidate cells to be cancelled for the lower-layer signaling based cell change or addition.

In some embodiments where the first message indicates the initialization of the configuration, the DU 151 may determine a set of candidate cells of the DU 151 for the lower-layer signaling based cell change or addition, and transmit, to the CU and in the positive response, ID information of the set of candidate cells of the DU 151.

In some embodiments, the DU 151 may transmit, to the CU 141, a second message for requesting a cancellation of a configuration for the lower-layer signaling based cell change or addition.

In some embodiments, the DU 151 may transmit, to the CU 141, a first configuration for a lower-layer measurement and report for a set of candidate cells of the first DU, and receive, from the CU 141, a second configuration for a lower-layer measurement and report for a set of candidate cells of at least one candidate DU.

In some embodiments, the DU 151 may receive, from the CU 141, information of a set of candidate cells of at least one candidate DU, and generate a third configuration for a lower-layer measurement and report for the set of candidate cells of the at least one candidate DU. Then the DU 151 may transmit the third configuration to the CU 141.

With the method 600, a DU may make decision directly on a target cell and inform the decision to a CU. Thus, latency over F1 interface due to message exchange between a CU and a DU may be avoided.

FIG. 7 illustrates an example method 700 of communication implemented at a CU in accordance with some embodiments of the present disclosure. For example, the method 700 may be performed at the CU 141 as shown in FIG. 1D. For the purpose of discussion, in the following, the method 700 will be described with reference to FIG. 1D. It is to be understood that the method 700 may include additional blocks not shown and/or may omit some blocks as shown, and the scope of the present disclosure is not limited in this regard. In this example, the DU 151 serves the terminal device 110, and the DU 152 does not serve the terminal device 110. That is, the DU 151 serves as a source DU. The DU 152 serves as a candidate (i.e., candidate DU) of a target DU.

At block 710, the CU 141 receives, from a source DU (e.g., the DU 151), first information regarding at least one candidate cell for a lower-layer signaling based cell change or addition.

In some embodiments, the first information may comprise at least one of the following: ID information of the at least one candidate cell, RS or TCI information of the at least one candidate cell, or measurement results of the at least one candidate cell.

At block 720, the CU 141 determines, based on the first information, a target cell for the lower-layer signaling based cell change or addition.

At block 730, the CU 141 transmits, to the DU 151, second information regarding the target cell for the lower-layer signaling based cell change or addition.

In some embodiments, the second information may comprise at least one of the following: ID information of the target cell, RS or TCI information of the target cell, a dedicated RA configuration for the cell change or addition, or a configuration of TA for the target cell.

In some embodiments where the target cell is associated with a second DU (e.g., the DU 152), the CU 141 may transmit, to the DU 152, an indication indicating that the cell change or addition is to be triggered for the target cell, and receive, from the DU 152, an acknowledgement for the triggering.

In some embodiments, the indication may comprise at least one of the following: identity information of the target cell, or RS or TCI information of the target cell. In some embodiments, the acknowledgement may comprise at least one of the following: a dedicated RA configuration for the cell change or addition, or a configuration of TA for the target cell.

In some embodiments, the CU 141 may transmit, to the DU 151, a first message indicating an initialization, modification or cancellation of a configuration for the lower-layer signaling based cell change or addition. In some embodiments where a context of a terminal device (for example, the terminal device 110) is modified successfully based on the first message, the CU 141 may receive, from the DU 151, a positive response to the first message.

In some embodiments where the context of the terminal device 110 is not modified successfully based on the first message, the CU 141 may receive, from the first DU, a negative response to the first message.

In some embodiments where the first message indicates the initialization of the configuration, the CU 141 may receive, in the positive response, ID information of a set of candidate cells of the DU 151. In some embodiments, the first message may comprise at least one of the following: an indication of the initialization, modification or cancellation of the configuration for the lower-layer signaling based cell change or addition; ID information of a set of candidate cells of the DU 151 for the lower-layer signaling based cell change or addition; ID information of a set of candidate cells to be cancelled for the lower-layer signaling based cell change or addition.

In some embodiments where the target cell is associated with a second DU (e.g., the DU 152), the CU 141 may transmit, to the DU 152, a third message indicating an initialization or modification of a configuration for the lower-layer signaling based cell change or addition; receive, from the DU 152, a positive response to the second message if a context of a terminal device is established successfully; and receive, from the DU 152, a negative response to the second message if the context of the terminal device is not established successfully.

In some embodiments where the third message indicates the initialization of the configuration, the CU 141 may receive, in the positive response, ID information of a set of candidate cells of the second DU.

In some embodiments, the third message may comprise at least one of the following: an indication of the initialization, modification or cancellation of the configuration for the lower-layer signaling based cell change or addition; ID information of a terminal device; or identity information of a set of candidate cells of the DU 152.

In some embodiments where the target cell is associated with the DU 152, the CU 141 may transmit, to the second DU, a fourth message indicating a cancellation of a configuration for the lower-layer signaling based cell change or addition.

In some embodiments, the CU 141 may receive, from the DU 151, a second message for requesting a cancellation of a configuration for the lower-layer signaling based cell change or addition.

In some embodiments where the target cell is associated with the DU 152, the CU 141 may receive, from the DU 152, a fifth message for requesting a cancellation of a configuration for the lower-layer signaling based cell change or addition.

In some embodiments, the CU 141 may receive, from the DU 151, a first configuration for a lower-layer measurement and report for a set of candidate cells of the DU 151; and transmit the first configuration to at least one candidate DU.

In some embodiments, the CU 141 may receive, from at least one candidate DU, a second configuration for a lower-layer measurement and report for a set of candidate cells of the at least one candidate DU, and transmit the second configuration to the DU 151.

In some embodiments, the CU 141 may transmit, to the DU 151, information of a set of candidate cells of at least one candidate DU; and receive, from the DU 151, a third configuration for a lower-layer measurement and report for the set of candidate cells of the at least one candidate DU.

In some embodiments, the CU 141 may transmit, to at least one candidate DU, information of a set of candidate cells of the DU 151; and receive, from the at least one candidate DU, a fourth configuration for a lower-layer measurement and report for the set of candidate cells of the DU 151.

With the method 700, a CU may have overall control for L1/L2 based mobility.

FIG. 8 illustrates another example method 800 of communication implemented at a CU in accordance with some embodiments of the present disclosure. For example, the method 800 may be performed at the CU 141 as shown in FIG. 1D. For the purpose of discussion, in the following, the method 800 will be described with reference to FIG. 1D. It is to be understood that the method 800 may include additional blocks not shown and/or may omit some blocks as shown, and the scope of the present disclosure is not limited in this regard. In this example, the DU 151 serves the terminal device 110, and the DU 152 does not serve the terminal device 110. That is, the DU 151 serves as a source DU. The DU 152 serves as a candidate (i.e., candidate DU) of a target DU.

At block 810, the CU 141 receives, from a source DU (e.g., the DU 151), third information indicating that a lower-layer signaling based cell change or addition is triggered for a target cell.

In some embodiments where the target cell is associated with a second DU (e.g., the DU 152), the CU 141 may transmit, to the DU 152, an indication indicating that the lower-layer signaling based cell change or addition is to be triggered for the target cell. The CU 141 may receive, from the DU 152, an acknowledgement for the triggering, the acknowledgement comprising fourth information regarding the target cell for the lower-layer signaling based cell change or addition, and transmit the fourth information to the DU 151.

In some embodiments, the indication may comprise at least one of the following: identity information of the target cell, or RS or TCI information of the target cell. In some embodiments, the acknowledgement may comprise at least one of the following: a dedicated RA configuration for the lower-layer signaling based cell change or addition, or a configuration of TA for the target cell.

In some embodiments, the CU 141 may transmit, to the DU 151, a first message indicating an initialization, modification or cancellation of a configuration for the lower-layer signaling based cell change or addition. In some embodiments where a context of a terminal device (for example, the terminal device 110) is modified successfully based on the first message, the CU 141 may receive, from the DU 151, a positive response to the first message. In some embodiments where the context of the terminal device 110 is not modified successfully based on the first message, the CU 141 may receive, from the first DU, a negative response to the first message.

In some embodiments where the first message indicates the initialization of the configuration, the CU 141 may receive, in the positive response, ID information of a set of candidate cells of the DU 151. In some embodiments, the first message may comprise at least one of the following: an indication of the initialization, modification or cancellation of the configuration for the lower-layer signaling based cell change or addition; ID information of a set of candidate cells of the DU 151 for the lower-layer signaling based cell change or addition; ID information of a set of candidate cells to be cancelled for the lower-layer signaling based cell change or addition.

In some embodiments where the target cell is associated with a second DU (e.g., the DU 152), the CU 141 may transmit, to the DU 152, a third message indicating an initialization or modification of a configuration for the lower-layer signaling based cell change or addition;

receive, from the DU 152, a positive response to the second message if a context of a terminal device is established successfully; and receive, from the DU 152, a negative response to the second message if the context of the terminal device is not established successfully.

In some embodiments where the third message indicates the initialization of the configuration, the CU 141 may receive, in the positive response, ID information of a set of candidate cells of the second DU.

In some embodiments, the third message may comprise at least one of the following: an indication of the initialization, modification or cancellation of the configuration for the lower-layer signaling based cell change or addition; ID information of a terminal device; or identity information of a set of candidate cells of the DU 152.

In some embodiments where the target cell is associated with the DU 152, the CU 141 may transmit, to the second DU, a fourth message indicating a cancellation of a configuration for the lower-layer signaling based cell change or addition.

In some embodiments, the CU 141 may receive, from the DU 151, a second message for requesting a cancellation of a configuration for the lower-layer signaling based cell change or addition.

In some embodiments where the target cell is associated with the DU 152, the CU 141 may receive, from the DU 152, a fifth message for requesting a cancellation of a configuration for the lower-layer signaling based cell change or addition.

In some embodiments, the CU 141 may receive, from the DU 151, a first configuration for a lower-layer measurement and report for a set of candidate cells of the DU 151; and transmit the first configuration to at least one candidate DU.

In some embodiments, the CU 141 may receive, from at least one candidate DU, a second configuration for a lower-layer measurement and report for a set of candidate cells of the at least one candidate DU, and transmit the second configuration to the DU 151.

In some embodiments, the CU 141 may transmit, to the DU 151, information of a set of candidate cells of at least one candidate DU; and receive, from the DU 151, a third configuration for a lower-layer measurement and report for the set of candidate cells of the at least one candidate DU.

In some embodiments, the CU 141 may transmit, to at least one candidate DU, information of a set of candidate cells of the DU 151; and receive, from the at least one candidate DU, a fourth configuration for a lower-layer measurement and report for the set of candidate cells of the DU 151.

With the method 800, CU-DU interworking for L1/L2 based mobility may be defined.

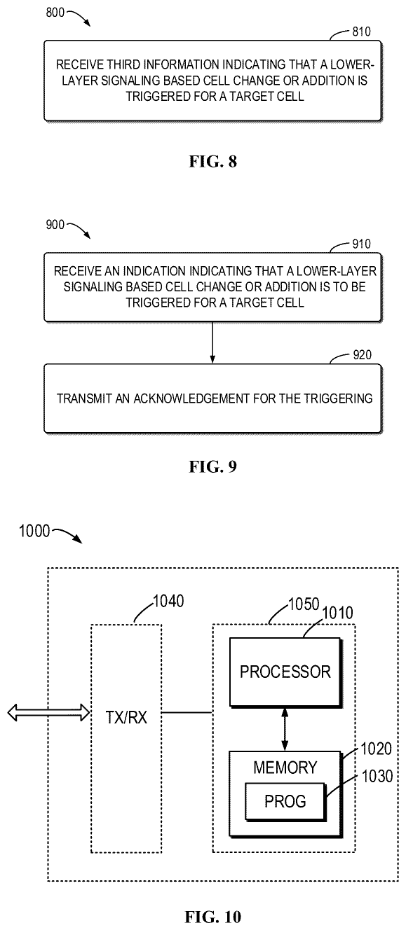

FIG. 9 illustrates an example method 900 of communication implemented at a second DU as a target DU in accordance with some embodiments of the present disclosure.

For example, the method 900 may be performed at the DU 152 as shown in FIG. 1D. For the purpose of discussion, in the following, the method 900 will be described with reference to FIG. 1D. It is to be understood that the method 900 may include additional blocks not shown and/or may omit some blocks as shown, and the scope of the present disclosure is not limited in this regard. In this example, the DU 151 serves the terminal device 110, and the DU 152 does not serve the terminal device 110. That is, the DU 151 serves as a source DU. The DU 152 serves as a candidate (i.e., candidate DU) of a target DU.

At block 910, the DU 152 receives and from the CU 141, an indication indicating that a lower-layer signaling based cell change or addition is to be triggered for a target cell, the target cell being associated with the DU 152. In some embodiments, the indication may comprise at least one of the following: ID information of the target cell, or RS or TCI information of the target cell.

At block 920, the DU 152 transmits, to the CU 141, an acknowledgement for the triggering. In some embodiments, the acknowledgement may comprise at least one of the following: a dedicated RA configuration for the cell change or addition, or a configuration of TA for the target cell.

In some embodiments, the DU 152 may receive, from the CU 141, a third message indicating an initialization or modification of a configuration for the lower-layer signaling based cell change or addition; transmit, to the CU 141, a positive response to the second message if a context of a terminal device (for example, the terminal device 110) is established successfully; and transmit, to the CU 141, a negative response to the second message if the context of the terminal device 110 is not established successfully.

In some embodiments where the third message indicates the initialization of the configuration, the DU 152 may transmit, in the positive response, ID information of a set of candidate cells of the DU 152.

In some embodiments, the third message may comprise at least one of the following: an indication of the initialization, modification or cancellation of the configuration for the lower-layer signaling based cell change or addition; ID information of the terminal device 110; or ID information of a set of candidate cells of the DU 152.

In some embodiments, the DU 152 may receive, from the CU 141, a fourth message indicating a cancellation of a configuration for the lower-layer signaling based cell change or addition.

In some embodiments, the DU 152 may transmit, to the CU 141, a fifth message for requesting a cancellation of a configuration for the lower-layer signaling based cell change or addition.

In some embodiments, the DU 152 may transmit, to the CU 141, a configuration for a lower-layer measurement and report for a set of candidate cells of the second DU; and receive, from the CU 141, a configuration for a lower-layer measurement and report for a set of candidate cells of a first DU.

In some embodiments, the DU 152 may receive, from the CU 141, information of a set of candidate cells of a first DU (e.g., the DU 151); generate a fifth configuration for a lower-layer measurement and report for the set of candidate cells of the DU 151; and transmit the fifth configuration to the CU 141.

With the method 900, CU-DU interworking for L1/L2 based mobility may be defined.

It is to be understood that the operations of methods 500 to 900 are similar as that described in connection with FIGS. 2 to 4C, and thus other details are not repeated here for concise.

### Example Implementation of Devices and Apparatuses

FIG. 10 is a simplified block diagram of a device 1000 that is suitable for implementing embodiments of the present disclosure. The device 1000 can be considered as a further example implementation of the CU 141 and the DU 151 and 152 as shown in FIG. 1D. Accordingly, the device 1000 can be implemented at or as at least a part of the CU 141 and the DU 151 and 152.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 2 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a first DU comprises a circuitry configured to: transmit, to a CU, first information regarding at least one candidate cell for a lower-layer signaling based cell change or addition; and receive, from the CU, second information regarding a target cell for the lower-layer signaling based cell change or addition.

In some embodiments, a first DU comprises a circuitry configured to: determine a target cell for a lower-layer signaling based cell change or addition; and transmit, to a CU, third information indicating that the lower-layer signaling based cell change or addition is triggered for the target cell.

In some embodiments, a CU comprises a circuitry configured to: receive, from a first DU, first information regarding at least one candidate cell for a lower-layer signaling based cell change or addition; determine, based on the first information, a target cell for the lower-layer signaling based cell change or addition; and transmit, to the first DU, second information regarding the target cell for the lower-layer signaling based cell change or addition.

In some embodiments, a CU comprises a circuitry configured to: receive, from a first DU, third information indicating that a cell change or addition based on a lower-layer signaling is triggered for a target cell.

In some embodiments, a second DU comprises a circuitry configured to: receive, from a CU, an indication indicating that a lower-layer signaling based cell change or addition is to be triggered for a target cell, the target cell being associated with the second DU; and transmit, to the CU, an acknowledgement for the triggering.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.
Clause 1. A method of communication, comprising:
transmitting, at first distributed unit (DU) and to a central unit (CU), first information regarding at least one candidate cell for a lower-layer signaling based cell change or addition; and
receiving, from the CU, second information regarding a target cell for the lower-layer signaling based cell change or addition.
Clause 2. The method of Clause 1, wherein the first information comprises at least one of the following:
identity information of the at least one candidate cell,
reference signal (RS) or transmission configuration indicator (TCI) information of the at least one candidate cell, or
measurement results of the at least one candidate cell.
Clause 3. The method of Clause 1, wherein the second information comprises at least one of the following:
identity information of the target cell,
reference signal (RS) or transmission configuration indicator (TCI) information of the target cell,
a dedicated random access configuration for the cell change or addition, or
a configuration of timing advance for the target cell.
Clause 4. A method of communication, comprising:
determining, at a first distributed unit (DU), a target cell for a lower-layer signaling based cell change or addition; and
transmitting, to a central unit (CU), third information indicating that the lower-layer signaling based cell change or addition is triggered for the target cell.
Clause 5. The method of Clause 4, wherein the third information comprises at least one of the following:
identity information of the target cell, or
reference signal (RS) or transmission configuration indicator (TCI) information of the target cell.
Clause 6. The method of Clause 4, further comprising:
receiving, from the CU, fourth information regarding the target cell for the lower-layer signaling based cell change or addition.
Clause 7. The method of Clause 6, wherein the fourth information comprises at least one of the following:
a dedicated random access configuration for the lower-layer signaling based cell change or addition, or
a configuration of timing advance for the target cell.
Clause 8. The method of Clause 1 or 4, further comprising:
receiving, from the CU, a first message indicating an initialization, modification or cancellation of a configuration for the lower-layer signaling based cell change or addition;
in accordance with a determination that a context of a terminal device is modified successfully based on the first message, transmitting a positive response to the first message; and
in accordance with a determination that the context of the terminal device is not modified successfully based on the first message, transmitting a negative response to the first message.
Clause 9. The method of Clause 8, wherein the first message comprises at least one of the following:
an indication of the initialization, modification or cancellation of the configuration for the lower-layer signaling based cell change or addition;
identity information of a set of candidate cells of the first DU for the lower-layer signaling based cell change or addition; or
identity information of a set of candidate cells to be cancelled for the lower-layer signaling based cell change or addition.
Clause 10. The method of Clause 8, wherein the first message indicates the initialization of the configuration, and wherein transmitting the positive response comprises:
determining a set of candidate cells of the first DU for the lower-layer signaling based cell change or addition; and
transmitting, to the CU and in the positive response, identity information of the set of candidate cells of the first DU.
Clause 11. The method of Clause 1 or 4, further comprising:
transmitting, to the CU, a second message for requesting a cancellation of a configuration for the lower-layer signaling based cell change or addition.
Clause 12. The method of Clause 1 or 4, further comprising:
transmitting, to the CU, a first configuration for a lower-layer measurement and report for a set of candidate cells of the first DU; and
receiving, from the CU, a second configuration for a lower-layer measurement and report for a set of candidate cells of at least one candidate DU.
Clause 13. The method of Clause 1 or 4, further comprising:
receiving, from the CU, information of a set of candidate cells of at least one candidate DU
generating a third configuration for a lower-layer measurement and report for the set of candidate cells of the at least one candidate DU; and
transmitting the third configuration to the CU.
Clause 14. A method of communication, comprising:
receiving, at a central unit (CU) and from a first distributed unit (DU), first information regarding at least one candidate cell for a lower-layer signaling based cell change or addition;
determining, based on the first information, a target cell for the lower-layer signaling based cell change or addition; and
transmitting, to the first DU, second information regarding the target cell for the lower-layer signaling based cell change or addition.
Clause 15. The method of Clause 14, wherein the first information comprises at least one of the following:
identity information of the at least one candidate cell,
reference signal (RS) or transmission configuration indicator (TCI) information of the at least one candidate cell, or
measurement results of the at least one candidate cell.
Clause 16. The method of Clause 14, wherein the second information comprises at least one of the following:
identity information of the target cell,
reference signal (RS) or transmission configuration indicator (TCI) information of the target cell,
a dedicated random access configuration for the cell change or addition, or
a configuration of timing advance for the target cell.
Clause 17. The method of Clause 14, wherein the target cell is associated with a second DU, and wherein the method further comprises:
transmitting, to the second DU, an indication indicating that the cell change or addition is to be triggered for the target cell; and
receiving, from the second DU, an acknowledgement for the triggering.
Clause 18. The method of Clause 17, wherein the indication comprises at least one of the following:
identity information of the target cell, or
reference signal (RS) or transmission configuration indicator (TCI) information of the target cell.
Clause 19. The method of Clause 17, wherein the acknowledgement comprises at least one of the following:
a dedicated random access configuration for the cell change or addition, or
a configuration of timing advance for the target cell.
Clause 20. A method of communication, comprising:
receiving, at a central unit (CU) and from a first distributed unit (DU), third information indicating that a lower-layer signaling based cell change or addition is triggered for a target cell.
Clause 21. The method of Clause 20, wherein the target cell is associated with a second DU, and wherein the method further comprises:
transmitting, to the second DU, an indication indicating that the lower-layer signaling based cell change or addition is to be triggered for the target cell;
receiving, from the second DU, an acknowledgement for the triggering, the acknowledgement comprising fourth information regarding the target cell for the lower-layer signaling based cell change or addition; and
transmitting the fourth information to the first DU.
Clause 22. The method of Clause 21, wherein the indication comprises at least one of the following:
identity information of the target cell, or
reference signal (RS) or transmission configuration indicator (TCI) information of the target cell.
Clause 23. The method of Clause 21, wherein the acknowledgement comprises at least one of the following:
a dedicated random access configuration for the lower-layer signaling based cell change or addition, or
a configuration of timing advance for the target cell.
Clause 24. The method of Clause 14 or 20, further comprising:
transmitting, to the first DU, a first message indicating an initialization, modification or cancellation of a configuration for the lower-layer signaling based cell change or addition;
receiving, from the first DU, a positive response to the first message if a context of a terminal device is modified successfully based on the first message; and
receiving, from the first DU, a negative response to the first message if the context of the terminal device is not modified successfully based on the first message.
Clause 25. The method of Clause 24, wherein the first message indicates the initialization of the configuration, and wherein receiving the positive response comprises:
receiving, in the positive response, identity information of a set of candidate cells of the first DU.
Clause 26. The method of Clause 24, wherein the first message comprises at least one of the following:
an indication of the initialization, modification or cancellation of the configuration for the lower-layer signaling based cell change or addition;
identity information of a set of candidate cells of the first DU for the lower-layer signaling based cell change or addition; or
identity information of a set of candidate cells to be cancelled for the lower-layer signaling based cell change or addition.
Clause 27. The method of Clause 14 or 20, wherein the target cell is associated with a second DU, and wherein the method further comprises:
transmitting, to the second DU, a third message indicating an initialization or modification of a configuration for the lower-layer signaling based cell change or addition;
receiving, from the second DU, a positive response to the second message if a context of a terminal device is established successfully; and
receiving, from the second DU, a negative response to the second message if the context of the terminal device is not established successfully.
Clause 28. The method of Clause 27, wherein the third message indicates the initialization of the configuration, and wherein receiving the positive response comprises:
receiving, in the positive response, identity information of a set of candidate cells of the second DU.
Clause 29. The method of Clause 27, wherein the third message comprises at least one of the following:
an indication of the initialization, modification or cancellation of the configuration for the lower-layer signaling based cell change or addition;
identity information of a terminal device; or
identity information of a set of candidate cells of the second DU.
Clause 30. The method of Clause 14 or 20, wherein the target cell is associated with a second DU, and wherein the method further comprises:
transmitting, to the second DU, a fourth message indicating a cancellation of a configuration for the lower-layer signaling based cell change or addition.
Clause 31. The method of Clause 14 or 20, further comprising:
receiving, from the first DU, a second message for requesting a cancellation of a configuration for the lower-layer signaling based cell change or addition.
Clause 32. The method of Clause 14 or 20, wherein the target cell is associated with a second DU, and wherein the method further comprises:
receiving, from the second DU, a fifth message for requesting a cancellation of a configuration for the lower-layer signaling based cell change or addition.
Clause 33. The method of Clause 14 or 20, further comprising:
receiving, from the first DU, a first configuration for a lower-layer measurement and report for a set of candidate cells of the first DU; and
transmitting the first configuration to at least one candidate DU.
Clause 34. The method of Clause 14 or 20, further comprising:
receiving, from at least one candidate DU, a second configuration for a lower-layer measurement and report for a set of candidate cells of the at least one candidate DU; and
transmitting the second configuration to the first DU.
Clause 35. The method of Clause 14 or 20, further comprising:
transmitting, to the first DU, information of a set of candidate cells of at least one candidate DU; and
receiving, from the first DU, a third configuration for a lower-layer measurement and report for the set of candidate cells of the at least one candidate DU.
Clause 36. The method of Clause 14 or 20, wherein the method further comprises:
transmitting, to at least one candidate DU, information of a set of candidate cells of the first DU; and
receiving, from the at least one candidate DU, a fourth configuration for a lower-layer measurement and report for the set of candidate cells of the first DU.
Clause 37. A method of communication, comprising:
receiving, at a second distribute unit (DU) and from a central unit (CU), an indication indicating that a lower-layer signaling based cell change or addition is to be triggered for a target cell, the target cell being associated with the second DU; and
transmitting, to the CU, an acknowledgement for the triggering.
Clause 38. The method of Clause 37, wherein the indication comprises at least one of the following:
identity information of the target cell, or
reference signal (RS) or transmission configuration indicator (TCI) information of the target cell.
Clause 39. The method of Clause 37, wherein the acknowledgement comprises at least one of the following:
a dedicated random access configuration for the cell change or addition, or
a configuration of timing advance for the target cell.
Clause 40. The method of Clause 37, further comprising:
receiving, from the CU, a third message indicating an initialization or modification of a configuration for the lower-layer signaling based cell change or addition;
transmitting, to the CU, a positive response to the second message if a context of a terminal device is established successfully; and
transmitting, to the CU, a negative response to the second message if the context of the terminal device is not established successfully.
Clause 41. The method of Clause 40, wherein the third message indicates the initialization of the configuration, and wherein transmitting the positive response comprises:
transmitting, in the positive response, identity information of a set of candidate cells of the second DU.
Clause 42. The method of Clause 40, wherein the third message comprises at least one of the following:
an indication of the initialization, modification or cancellation of the configuration for the lower-layer signaling based cell change or addition;
identity information of the terminal device; or
identity information of a set of candidate cells of the second DU.
Clause 43. The method of Clause 37, further comprising:
receiving, from the CU, a fourth message indicating a cancellation of a configuration for the lower-layer signaling based cell change or addition.
Clause 44. The method of Clause 37, further comprising:
transmitting, to the CU, a fifth message for requesting a cancellation of a configuration for the lower-layer signaling based cell change or addition.
Clause 45. The method of Clause 37, further comprising:
transmitting, to the CU, a configuration for a lower-layer measurement and report for a set of candidate cells of the second DU; and
receiving, from the CU, a configuration for a lower-layer measurement and report for a set of candidate cells of a first DU.
Clause 46. The method of Clause 37, further comprising:
receiving, from the CU, information of a set of candidate cells of a first DU;
generating a fifth configuration for a lower-layer measurement and report for the set of candidate cells of the first DU; and
transmitting the fifth configuration to the CU.
Clause 47. A distributed unit (DU), comprising:
a processor configured to cause the DU to perform the method according to any of Clauses 1 to 19 or any of Clauses 37 to 46.
Clause 48. A central unit (CU), comprising:
a processor configured to cause the CU to perform the method according to any of Clauses 20 to 36.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method for a source distributed unit (DU), the method comprising:
receiving a lower-layer measurement report from a terminal device;
determining a target cell for a lower-layer signaling based cell change or addition; and
transmitting, to a central unit (CU), a first message indicating that the lower-layer signaling based cell change or addition is triggered for the target cell.

22. The method according to claim 21, wherein the first message comprises at least one of the following:
an identity information of the target cell, or
reference signal (RS) or transmission configuration indicator (TCI) information of the target cell.

23. The method according to claim 21, wherein
the lower-layer measurement report is a L1 measurement report, and
the lower-layer signaling based cell change or addition is a L1/L2 signaling based cell change or addition.

24. The method according to claim 21, further comprising:
receiving, from the CU, a second message regarding the target cell for the lower-layer signaling based cell change or addition.

25. A method for a central unit (CU), the method comprising:
transmitting, to at least one candidate distributed unit (DU) for a lower-layer signaling based cell change or addition, a user equipment (UE) context setup request message which includes a configuration for a lower-layer measurement;
receiving, from a source DU, a first message indicating that the lower-layer signaling based cell change or addition is initiated; and
transmitting, to a target DU which is one of the at least one candidate DU, an identity information of a target cell or a transmission configuration indicator (TCI) information of the target cell.

26. The method according to claim 25, wherein
the lower-layer signaling based cell change or addition is a L1/L2 signaling based cell change or addition.

27. The method according to claim 25, wherein the first message comprises at least one of the following:
an identity information of the target cell, or
reference signal (RS) information or the TCI information of the target cell.

28. The method according to claim 25, further comprising:
transmitting, to the source DU, a second message regarding the target cell for the lower-layer signaling based cell change or addition.

29. A method for a terminal device, the method comprising:
transmitting a lower-layer measurement report to a source distributed unit (DU);
receiving a lower-layer signal for a lower-layer signaling based cell change or addition from the source DU, which received the lower-layer measurement report and determined a target cell for the lower-layer signaling based cell change or addition.

30. The method according to claim 29, wherein
the lower-layer measurement report is a L1 measurement report, and
the lower-layer signaling based cell change or addition is a L1/L2 signaling based cell change or addition.

31. A source distributed unit (DU), comprising:
at least one memory having instructions stored therein;
at least one processor configured to executed the instructions, that when executed control the source DU to perform operations comprising:
receiving a lower-layer measurement report from a terminal device;
determining a target cell for a lower-layer signaling based cell change or addition; and
transmitting, to a central unit (CU), a first message indicating that the lower-layer signaling based cell change or addition is triggered for the target cell.

32. A central unit (CU), comprising:
at least one memory having instructions stored therein;
at least one processor configured to executed the instructions, that when executed control the CU to perform operations comprising:
transmitting, to at least one candidate distributed unit (DU) for a lower-layer signaling based cell change or addition, a user equipment (UE) context setup request message which includes a configuration for a lower-layer measurement;
receiving, from a source DU, a first message indicating that the lower-layer signaling based cell change or addition is initiated; and
transmitting, to a target DU which is one of the at least one candidate DU, an identity information of a target cell or a transmission configuration indicator (TCI) information of the target cell.
